(19) United States
(12) Patent Application Publication
(10) Pub. No.: US 2026/0162880 A1
(43) Pub. Date: Jun. 11, 2026

(54) COIL COMPONENT

(71) Applicant: SAMSUNG ELECTRO-MECHANICS CO., LTD., Suwon-si (KR)

(72) Inventors: Ju Hwan Yang, Suwon-si (KR); Boum Seock Kim, Suwon-si (KR)

(73) Assignee: SAMSUNG ELECTRO-MECHANICS CO., LTD., Suwon-si (KR)

(21) Appl. No.: 19/181,099

(22) Filed: Apr. 16, 2025

(30) Foreign Application Priority Data
Jun. 27, 2024 (KR) 10-2024-0084339
Dec. 18, 2024 (KR) 10-2024-0190025

(51) Int. Cl. H01F 27/30

(52) U.S. Cl. CPC H01F 27/306

(57) ABSTRACT

A coil component includes a body including a magnetic material; a support member disposed in the body and including a plurality of groove portions formed in one surface; and a coil disposed on the one surface of the support member and forming at least one turn, wherein the plurality of groove portions include a plurality of first groove portions formed in one region of the one surface of the support member in which the coil is not disposed and a plurality of second groove portions formed in the other region of the one surface of the support member in which the coil is disposed, and wherein an insulating material including epoxy is disposed in at least one of the plurality of first groove portions.

### CROSS-REFERENCE TO RELATED APPLICATION(S)

This application claims benefit of priority to Korean Patent Application No. 10-2024-0190025 filed on Dec. 18, 2024 and Korean Patent Application No. 10-2024-0084339 filed on Jun. 27, 2024 in the Korean Intellectual Property Office, the disclosures of which are incorporated herein by reference in their entirety.

### BACKGROUND

### 1. Field

The present disclosure relates to a coil component.

### 2. Description of Related Art

An inductor, a coil component, may be a representative passive electronic component in an electronic device along with a resistor and a capacitor.

As miniaturization and thinning of various electronic devices have been accelerated due to the development of IT technology, a film inductor having a reduced thickness used in these electronic devices has also required to be miniaturized and thinned.

As a size of a power inductor has been reduced, research and development have been conducted to increase the number of turns of a coil pattern (fine patterning) and increase a height of a coil pattern in order to implement miniaturization of a product without loss of chip characteristics such as inductance and Rdc.

As a coil pattern has been fine, adhesion between a coil pattern and a substrate may decrease, and a defect of coil lifting may occur.

### SUMMARY

An aspect of the present disclosure is to provide a coil component which may include a fine coil pattern and may ensure adhesive force with a support member.

According to an aspect of the present disclosure, a coil component includes a body including a magnetic material; a support member disposed in the body and including a plurality of groove portions formed in one surface; and a coil disposed on one surface of the support member and forming at least one turn, wherein the plurality of groove portions include a plurality of first groove portions formed in one region of one surface of the support member in which the coil is not disposed and a plurality of second groove portions formed in the other region of one surface of the support member in which the coil is disposed, and wherein an insulating material including epoxy is disposed in at least one of the plurality of first groove portions.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to an embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is an enlarged diagram illustrating A in FIG. 2;

FIG. 5 is a diagram illustrating a modified example of a coil component according to an embodiment of the present disclosure; and

FIG. 6 is a diagram illustrating a cross-section of a coil component according to a comparative example of the present disclosure.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments determined set forth herein. An exhibition used in the singular encompasses the exhibition of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the exhibition that an element is disposed “on” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

For example, structures, shapes, and sizes described as examples in embodiments in the present disclosure may be implemented in another exemplary embodiment without departing from the spirit and scope of the present disclosure.

In the drawings, the X-direction may be defined as a first direction or a length direction, the Y-direction may be defined as a second direction or a width direction, and the Z-direction may be defined as a third direction or a thickness direction.

In the drawings, the same elements will be indicated by the same reference numerals. Also, redundant descriptions and detailed descriptions of known functions and elements which may unnecessarily render the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a high frequency (HF) inductor, a general bead, a GHz bead, a common mode filter, or the like.

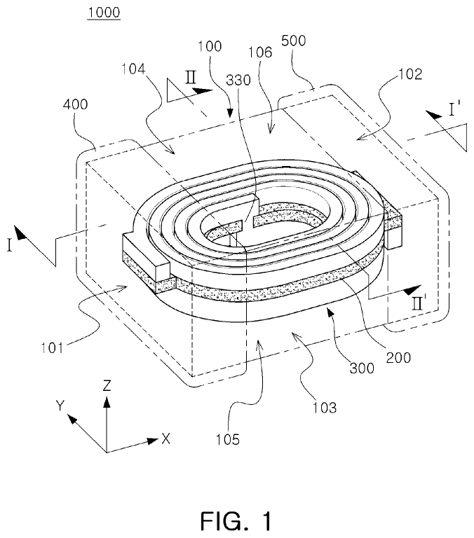

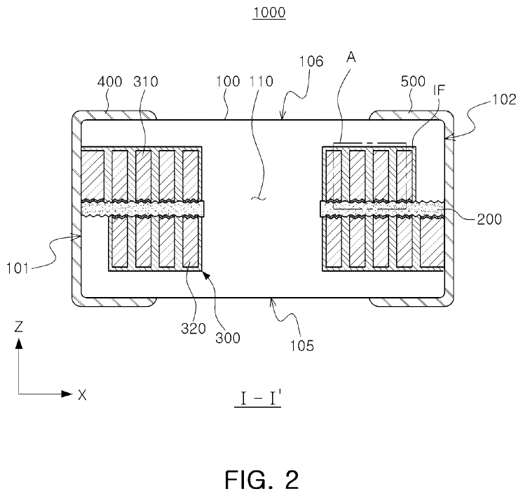

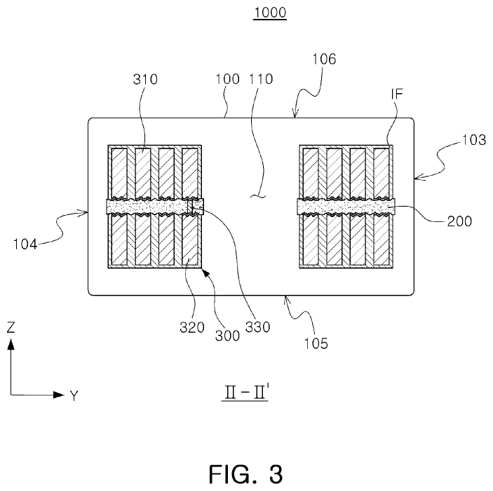

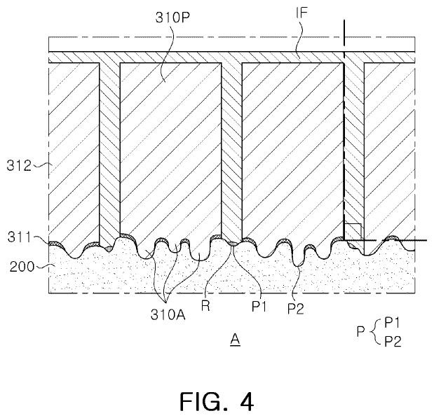

FIG. 1 is a perspective diagram illustrating a coil component according to one embodiment of the present disclosure. FIG. 2 is a cross-sectional diagram taken along line I-I′ in FIG. 1. FIG. 3 is a cross-sectional diagram taken along line II-II′ in FIG. 1. FIG. 4 is an enlarged diagram illustrating a region A in FIG. 2.

Referring to FIGS. 1 to 4, a coil component 1000 according to some embodiments includes a body 100, a support member 200 and a coil 300, and may further include external electrodes 400 and 500 and an insulating film IF.

The body 100 may form an overall exterior of the coil component 1000 in the embodiment, and the support member 200 and the coil 300 may be embedded therein.

The body 100 may have a hexahedral shape.

Referring to FIGS. 1 to 3, the body 100 may include a first surface 101 and a second surface 102 opposing each other in the first direction (X-direction), a third surface 103 and a fourth surface 104 opposing each other in the second direction (Y-direction), and a fifth surface 105 and a sixth surface 106 opposing each other in the third direction (Z-direction). The third to sixth surfaces 103, 104, 105, and 106 may be side surfaces connecting the first surface 101 to the second surface 102.

According to some embodiments of the present disclosure, a coil component 1000 in which the external electrodes 400 and 500 described below are disposed may have a length of 0.8 mm, a width of 0.65 mm, and a thickness of 0.45 mm, but the present disclosure is not limited thereto. However, the size of the coil component 1000 according to the embodiment described above is merely an example, and thus, the example in which the coil component 1000 has a size other than the above-described size is not excluded from the embodiments.

The body 100 may include magnetic powder and an insulating resin. Specifically, the body 100 may be formed by laminating one or more magnetic composite sheets including an insulating resin and magnetic powder dispersed in the insulating resin, and curing the magnetic composite sheet. However, the body 100 may have a structure other than a structure in which the magnetic powder is dispersed in an insulating resin. For example, the body 100 may be formed of a magnetic material such as ferrite.

The magnetic material included in the body 100 may be ferrite or metallic magnetic powder.

A ferrite powder may include at least one selected from the group consisting of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape. For example, the body 100 may include two or more magnetic powder particles having different average diameters.

The insulating resin may include an epoxy compound, polyimide, a liquid crystal polymer, or the like, alone or in combination, but an embodiment thereof is not limited thereto.

The body 100 may include a core 110 penetrating the support member 200 and coil 300 described below. The core 110 may be formed by filling a through-hole of the coil 300 with at least a portion of the magnetic composite sheet in a process of laminating and curing the magnetic composite sheet, but an embodiment thereof is not limited thereto.

The support member 200 may have one surface and the other surface opposing the one surface, and may be buried in the body 100 together with the coil 300 described below. The support member 200 may be configured to support the coil 300. In some embodiments of the present disclosure, one surface of the support member 200 is described for ease of description, but the embodiment of the present disclosure is not limited thereto, and the description of one surface of the support member 200 may be applied to the other surface of the support member 200 as well.

The support member 200 may be formed of an insulating material including a thermosetting insulating resin such as an epoxy resin, a thermoplastic insulating resin such as a polyimide, or a photosensitive insulating resin, or may be formed of an insulating material in which a reinforcing material such as glass fiber or an inorganic filler is impregnated into the insulating resin. For example, the support member 200 may include an insulating material such as a copper clad laminate (CCL), a prepreg, an Ajinomoto build-up film (ABF), a FR-4, a bismaleimide triazine (BT) film, a photoimageable dielectric (PID) film, or the like, but an embodiment thereof is not limited thereto.

In some embodiments, the inorganic filler may include one or more selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide better rigidity. When the support member 200 is formed of an insulating material not including glass fiber, the support member 200 may be advantageous in reducing a thickness of the entire coil 300. When the support member 200 is formed of an insulating material including a photosensitive insulating resin, the number of processes for forming the coil 300 is reduced, which may be advantageous in reducing production costs and fine vias may be formed.

Referring to FIGS. 2 to 4, the support member 200 may include a plurality of groove portions P formed in one surface.

The groove portion P may be recessed inwardly from one surface of the support member 200. As illustrated in FIG. 4, a plurality of the groove portions P may be formed along one surface of the support member 200, and the plurality of groove portions P may be spaced apart from each other. The groove portion P may be formed through a desmear process, a plasma treatment process, or the like, of the support member 200.

The plurality of groove portions P may include a plurality of first groove portions P1 formed in one region of one surface of the support member in which the coil is not disposed, and a plurality of second groove portions P2 formed on the other region of one surface of the support member in which the coil is disposed.

The plurality of first groove portions P1 may be formed in one region of one surface of the support member 200 in which the coil 300 is not disposed. The one region may include a region between adjacent turns of the coil. The first groove portion P1 may also be formed in a region between adjacent turns of the coil. Referring to FIG. 4, one first groove portion P1 is disposed between adjacent turns of the coil, but an embodiment thereof is not limited thereto. Two or more first groove portions P1 may be formed between the turns, and the number of first groove portions may be different from the number of the other turns.

The plurality of second groove portions P2 may be formed in the other region of one surface of the support member in which the coil is disposed. Referring to FIG. 4, the plurality of second groove portions P2 may be formed in a lower portion of a turn of one coil. The anchor portion 310A of the coil pattern may be disposed in the plurality of second groove portions P2, thereby ensuring adhesive force between the coil and the support member through an anchor effect.

The insulating material R including the epoxy compound may be a residue of dry film resist (DFR) when forming the coil 300 of the coil component 1000 according to some embodiments of the present disclosure. Even when the DFR is exposed and developed and a DFR peeling process is performed, contamination may occur on the surface of the support member 200 due to the DFR residue. Particularly, residual solvent of the film may remain on the groove portion P due to an increase in photoreactivity of the DFR.

The epoxy compound in insulating material R may include one or more selected from a group consisting of a bisphenol A (BPA) epoxy, novolac epoxy, and aliphatic epoxy. The insulating material R including the epoxy may not include oxetane.

An oxetane compound may be added to the epoxy compound and may improve curing properties and solvent resistance. Also, the oxetane compound may accelerate polymerization by epoxy ring-opening. However, the epoxy compound having increased photoreactivity due to the addition of the oxetane compound may cause issues such as residue defects on the surface of the support member. Particularly, when insulating material R including the epoxy compound is formed in the lower portion of coil 300, defects such as the coil 300 lifting may occur.

The coil component according to some embodiments of the present disclosure may not add an oxetane compound to the DFR for coil formation. Accordingly, the insulating material R including the epoxy compound, which is a residue of the DFR, may not include an oxetane compound. By not including the oxetane component, the DFR residual solvent remaining on the support member 200 may be reduced. Specifically, the insulating material R including epoxy may not be disposed in the second groove portion P2, and may be disposed only in at least one first groove portion P1.

The insulating material R including the epoxy compound may not be disposed in the second groove portion P2. The DFR of the region of the support member 200 in which the coil 300 is to be formed may be exposed. Since the exposed DFR portion is activated by the photoinitiator and a curing reaction occurs, no residue may remain. Since the insulating material R including epoxy is not formed in the second groove portion P2, the lifting of the coil 300 may not occur. Also, since the anchor portion 310A of the coil 300 may be disposed in the second groove portion P2, adhesive force and stability of the coil 300 may be ensured.

The insulating material R including the epoxy may be disposed in at least one of the plurality of first groove portions P1 of the support member 200. The DFR of the region of the turn adjacent to the coil 300 may be unexposed. The uncured DFR may remain in the first groove portion P1 in the form of residual solvent.

The coil 300 may be disposed on one surface of the support member 200, may form a plurality of turns and may exhibit characteristics of the coil component. For example, when the coil component 1000 in some embodiments is used as a power inductor, the coil 300 may stabilize power of the electronic device by storing an electric field as a magnetic field and maintaining an output voltage.

The coil 300 of the coil component according to some embodiments may cover a plurality of second groove portions P2 and may form at least one turn.

The coil 300 may include a first coil pattern 310 disposed on one surface of the support member 200 and a second coil pattern 320 disposed on the other surface of the support member 200 as described below, and may be described below with respect to the first coil pattern 310.

Referring to FIG. 4, the first coil pattern 310 may include an anchor portion 310A disposed on the second groove portion P2 and a pattern portion 310P disposed on the anchor portion and protruding to one surface of the support member 200.

The anchor portion 310A may be disposed on an inner side of the support member along the shape of the second groove portion P2. That is, the anchor portion 310A may be positioned at a level lower than a level of one surface of the support member 200 and may be inserted into the second groove portion P2, such that adhesive force with the support member 200 may be ensured through the anchor effect.

The pattern portion 310P may be disposed on the anchor portion 310A and may protrude from one surface of the support member 200. The pattern portion 310P may be positioned at a level higher than a level of one surface of the support member 200, may form one or more turns, and may form the capacitance of the coil component.

Referring to FIG. 4, a line width of the anchor portion 310A may be smaller than a line width of the pattern portion 310P. Here, the line width may indicate the length in the first direction (X-direction) in the X-direction-Z-direction cross-section of one turn of the first coil pattern 310.

Referring to FIGS. 2 to 4, one of the plurality of turns of the coil 300 may include a plurality of anchor portions 310A, and the plurality of anchor portions 310A may be spaced apart from each other. As described above, one turn may include a plurality of anchor portions, such that the anchor effect with the support member 200 may be maximized.

The first coil pattern 310 may include a first metal layer 311 disposed on the second groove portion P2 of the support member 200 and a second metal layer 312 disposed on the first metal layer. That is, the coil 300 in the embodiment may be a thin film type coil formed by a plating method.

The first metal layer 311 may be disposed on the second groove portion P2 of the support member 200. The first metal layer 311 may expose at least a portion of the second groove portion P2. The first metal layer 311 may not cover a portion of the second groove portion P2 by a desmearing process or a plasma treatment process for the support member 200 described above. The second metal layer 312 may be in direct contact with the support member 200 through the exposed portion.

The first metal layer 311 may be formed by a thin film process such as sputtering or an electroless plating process. The first metal layer 311 may include at least one selected from the group consisting of copper (Cu), aluminum (Al), silver (Ag), tin (Sn), gold (Au), nickel (Ni), lead (Pb), titanium (Ti), chromium (Cr), molybdenum (Mo), or an alloy thereof, and may be formed in at least one or more layers.

The second metal layer 312 may be disposed on the first metal layer 311, and at least a portion may be disposed on the second groove portion P2 of the support member. The second metal layer 312 may be formed by performing electroplating using the first metal layer 311 as a seed, and may include at least one selected from the group consisting of copper (Cu), aluminum (Al), silver (Ag), tin (Sn), gold (Au), nickel (Ni), platinum (Pt), titanium (Ti), chromium (Cr), or an alloy thereof, and may be formed in at least one or more layers.

When an insulating material R including epoxy remains on the support member 200, the coil 300 may be undercut when the coil 300 is formed.

The undercutting of the coil 300 may refer to the case in which the angle of the side surface of the coil 300 is formed to be less than 90 degrees, and since the line width in a lower portion of the coil is formed relatively narrower than that of the upper portion of the coil, defects such as falling off of the coil may occur.

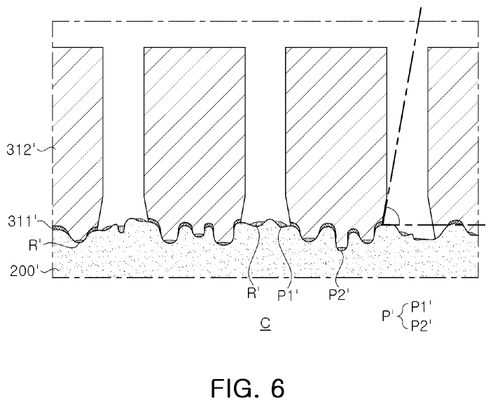

FIG. 6 is a diagram illustrating a cross-section of a coil component according to a comparative example. Referring to FIG. 6, an insulating material R′ including epoxy may be disposed in the groove portion P1′ in a lower portion of the coil, which may hinder smooth plating of the coil and may weaken adhesive force between the coil and the support member. The side surface of the coil may form an angle of 90 degrees or lower with respect to one surface of the support member, and a line width in a lower portion of the coil may be formed narrower than that of the upper portion of the coil. In this case, a defect of falling off of the coil may occur.

In the coil component 1000 according to the embodiment, since the insulating material R including epoxy is not disposed in the plurality of second groove portions P2, the second metal layer 312 of coil 300 may be stably formed on the support member 200.

The angle of the side surface of the coil 300 with respect to one surface of the support member 200 may be 90 degrees or more.

Referring to FIG. 4, the side surface of the coil 300 may form a 90 degree angle with respect to one surface of support member 200.

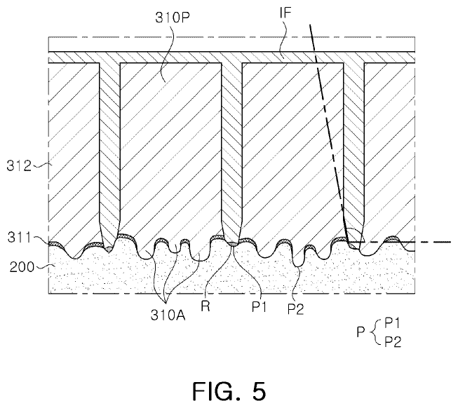

FIG. 5 is a diagram illustrating a modified example of a coil component according to an embodiment. Referring to FIG. 5, the side surface of the coil 300 may form an inclination angle greater than 90 degrees in a portion in which the side surface meets one surface of the support member 200. That is, the side surface in the lower portion of the coil 300 may form a gentle inclination angle. Accordingly, the lower portion of the coil 300 may have a line width greater than that of the upper portion of the coil. Specifically, the line width of the portion of the coil 300 meeting one surface of the support member 200 may be greater than the line width of the other portion.

The inclination angle formed by the side surface of the coil 300 and one surface of the support member 200 may be measured by the method as below. A cross-section sample may be obtained by polishing the cross-section in the first direction (X-direction)-third direction (Z-direction) to ½ depth. A surface formed by averaging the surface level of the groove portion P or a flat surface on which the groove portion P is not formed may be determined as a reference plane of one surface of the support member 200. The angle formed by the side surface of the coil 300 may be measured using a high-resolution scanning electron microscope (SEM) with respect to the reference plane of the support member 200.

The coil 300 may include first and second coil patterns 310, 320 and via 330. With respect to the directions of FIGS. 1, 2 and 3, the first coil pattern 310 may be disposed on one surface of the support member 200 opposing the sixth surface 106 of the body 100, and the second coil pattern 320 may be disposed on the other surface opposing the one surface of the support member 200

Referring to FIGS. 1 to 3, a via 330 may penetrate the support member 200 and may be in contact with and connected to a first coil pattern 310 disposed on one surface of the support member 200 and a second coil pattern 320 disposed on the other surface of the support member 200. Accordingly, the coil 300 may function as a single coil having one or more turns formed around the core 110.

The via 330 may include at least one or more plating layers. For example, when the via 330 is formed by electroplating, the via 330 may include a seed layer formed on an inner wall of a via hole penetrating the support member 200 and an electroplating layer filling the via hole on which the seed layer is formed. The seed layer of via 330 and the seed layer for forming the coil 300 may be formed together in the same process and may be formed integrally with each other, or may be formed in different processes and a boundary may be formed therebetween. The via 330 may include a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof.

The ends of the coil 300 may be connected to the first and second external electrodes 400 and 500, which will be described later, respectively. Referring to FIGS. 1 and 2, the end of the first coil pattern 310 may be exposed to the first surface 101 of the body 100 and may be connected to the first external electrode 400, and the end of the second coil pattern 320 may be exposed to the second surface 102 of the body 100 and connected to the second external electrode 500.

The first and second external electrodes 400 and 500 may be disposed on the first surface 101 and the second surface 102 of the body 100, respectively. The first external electrode 400 may be disposed on the first surface 101 of the body 100 and may be connected to the end of the first coil pattern 310. The second external electrode 500 may be disposed on the second surface 102 of the body 100 and may be connected to the end of the second coil pattern 320.

The first and second external electrodes 400 and 500 may be formed as a single-layer or multi-layer structure. For example, the first external electrode 400 may include a first layer including copper (Cu), a second layer disposed on the first layer and including nickel (Ni), and a third layer disposed on the second layer and including tin (Sn). Here, each of the first to third layers may be formed by plating, but an embodiment thereof is not limited thereto. As another example, the first external electrode 400 may include a resin electrode including conductive powder such as silver (Ag) and resin, and a nickel (Ni)/tin (Sn) plating layer formed by plating on the resin electrode.

The first and second external electrodes 400 and 500 may include a conductive material such as copper (Cu), aluminum (Al), silver (Ag), tin (Sn), gold (Au), nickel (Ni), lead (Pb), titanium (Ti), or an alloy thereof, but an embodiment thereof is not limited thereto.

The insulating film IF may be disposed along the surface of the coil 300.

The insulating film IF may insulate between the coil 300 and the body 100. The insulating film IF may cover the external surface of the coil 300, and may insulate the coil 300 from the body 100. The insulating film IF may be disposed between adjacent turns of the coil, and may cover at least one of the plurality of first groove portions P1. Also, the insulating material R including epoxy disposed in the first groove portion P1 and the insulating film IF may be in contact with each other.

The insulating film IF may include a generally used insulating material such as parylene, but an embodiment thereof is not limited thereto. As another example, the insulating film IF may include an insulating material such as epoxy resin other than parylene. The insulating film IF may be formed by a vapor deposition method, but an embodiment thereof is not limited thereto. As another example, the insulating film IF may be formed by laminating and curing an insulating film for forming an insulating film IF on both surfaces of the support member 200 on which the coil 300 is formed, or may be formed by applying and curing an insulating paste for forming an insulating film IF on both surfaces of the support member 200 on which the coil 300 is formed.

In the embodiments, the insulating film IF may be an optional component, such that when the body 100 may ensure sufficient electrical resistance under operating conditions of the coil component 1000 according to the embodiment, the insulating film IF may not be provided.

According to the aforementioned embodiments, a coil component which may include a fine coil pattern and may ensure adhesive force with a support member may be provided.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a magnetic material;
a support member disposed in the body and including a plurality of groove portions formed in one surface of the support member; and
a coil disposed on the one surface of the support member and forming at least one turn,
wherein the plurality of groove portions include a plurality of first groove portions formed in one region of the one surface of the support member in which the coil is not disposed and a plurality of second groove portions formed in other region of the one surface of the support member in which the coil is disposed, and
wherein an insulating material including an epoxy compound is disposed in at least one of the plurality of first groove portions.

2. The coil component of claim 1, wherein the epoxy compound includes one or more selected from a group consisting of BPA epoxy, novolac epoxy, and aliphatic epoxy.

3. The coil component of claim 1, wherein the insulating material does not include an oxetane compound.

4. The coil component of claim 1, wherein at least a portion of the coil is disposed in the plurality of second groove portions.

5. The coil component of claim 1, wherein the one region of the support member includes a region of the one surface of the support member between adjacent turns of the coil.

6. The coil component of claim 1, wherein the insulating material is not disposed in the plurality of second groove portions.

7. The coil component of claim 1, wherein the coil includes a first metal layer disposed on the plurality of second groove portions and a second metal layer disposed on the first metal layer.

8. The coil component of claim 7, wherein the first metal layer exposes at least a portion of a surface of the second groove portion.

9. The coil component of claim 8, wherein the second metal layer is in direct contact with the support member.

10. The coil component of claim 1, wherein an angle of a side surface of the coil with respect to the one surface of the support member is 90 degrees or more.

11. The coil component of claim 10, wherein a line width of a portion of the coil meeting the one surface of the support member is greater than a line width of the other portion of the coil.

12. The coil component of claim 1, further comprising:
an insulating film disposed along a surface of the coil.

13. The coil component of claim 12, wherein the insulating film is disposed between adjacent turns of the coil and covers the first groove portion.

14. The coil component of claim 1, further comprising:
an external electrode disposed on one surface of the body.
